(19) United States
(12) Patent Application Publication
(10) Pub. No.: US 2012/0188698 A1
(43) Pub. Date: Jul. 26, 2012

(54) Car audio system with changeable plug-in computer

(75) Inventor: Stephen Chen, Shengang Shiang (TW)

(73) Assignee: E-LEAD ELECTRONIC CO., LTD.

(21) Appl. No.: 12/929,400

(22) Filed: Jan. 21, 2011

(51) Int. Cl. G06F 1/16

(52) U.S. Cl. 361/679.21

(57) ABSTRACT

The car audio system with changeable plug-in computer of the present invention has a car audio device providing a display screen, an audio assembly, an external terminal base and a panel. The panel has at least one inserting slot for storage device and an operating press-button. An inserting slot is disposed at the back of the car audio device to allow the insertion and attachment of the plug-in computer module. The plug-in computer module has a terminal block to butt joint with the external terminal base. By assembling the foregoing assemblies, the present invention is hence capable of changing between different plug-in computer modules and achieves the goal of upgrading hardware without having to make changes on the car audio itself.

### BACKGROUND OF THE INVENTION

1. Field of the Invention

The present invention relates to a car audio system with changeable plug-in computer that is capable of changing between different plug-in computer modules and therefrom achieves the goal of upgrading hardware without having to make changes on the car audio.

2. Brief Description of the Related Art

The currently used car audio is usually of one-time design. As the market or customers require a change, manufacturers will produce a new model; this way increases the cost of human resource and material storage. Moreover, the computer CPU techniques are growing fast with time, and a car audio system is usually designed to match with the vehicle's other equipment; therefore, after a few years when the vehicle is still functioning well but the car audio CPU therein is already out-dated, it becomes a problem. If the car owner wants to replace the car audio CPU, it is very likely that the new model cannot match with the other equipment in car; and if the car user decides not the replace the car audio CPU, the advanced functions cannot be applied thereof.

Besides, the traditional car audio with display screen has to additionally attach a GPS device in order to apply GPS function thereon; however, this way causes the below problems:
(1) Due to the distance thereof, the display screen can only use analog type RGB and therefore has lower display quality.
(2) The removable memory cards, such as USB or SD, are usually placed on the GPS device body; and since the GPS device body is often disposed at spaces that are more private, such as a glove box or the trunk, it is not easy to plug in or out the USB of the GPS device body. For those GPS device body with data downloading function, it is even more inconvenient.

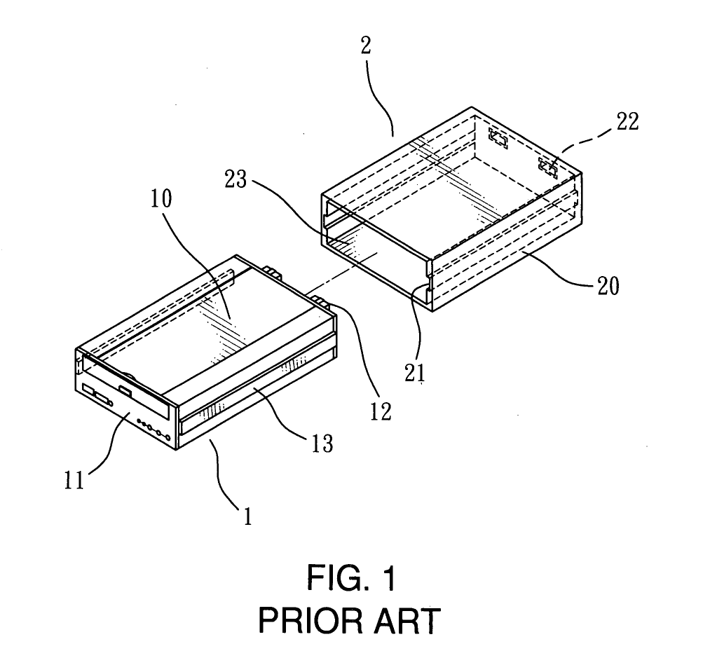

In order to solve the foregoing problems, the industry has proposed several different alternatives, especially focusing on designs with changeability and miniaturization of the assemblies thereof, intending to meet the new development trend of IT products with an integrated manner. FIG. 1 illustrates a removable microcomputer according to a prior art of Taiwan patent (No. M276254). The prior art comprises a microcomputer main body 1 and a removing case 2, wherein the microcomputer main body 1 comprises a casing 10, and therein comprises a micro motherboard, a CPU, a storage device and scratch pad memory. At least one connector 12 is disposed at the back of the casing 10, and a guide rail 13 is disposed at the lateral side of the casing 10. The removing case 2 is a case body 20 disposed at car audio slot or desktop computer CD slot, wherein the case body 20 has a receiving groove 23 to contain the microcomputer main body 1 and a connector 22 of correspondence with the connector 12, thereby forms the removable microcomputer that is capable of being disposed in cars, desktop computers or being used alone. The front end of the microcomputer main body 1 provides an operation panel 11. The microcomputer main body 1 seems like a changeable computer device; however, it is actually only a design to allow a fast assembling and detaching the microcomputer to a car or other equipment. In other words, in the foregoing prior art, the microcomputer main body 1 is designed to be capable of applying to different device or equipment conveniently without having to change its function. Therefore, this design cannot upgrade and computer or meet the new development trend of IT products requirement.

Similar prior arts such as Taiwan patents No. 593021, 1249038, 1314525, 1314528, M253165, M289129, 1311113, or 501780 are mostly used to connect with the other vehicle equipment, and yet unable to upgrade at any time when sharing a multimedia device.

### SUMMARY OF THE INVENTION

In order to overcome the deficiencies of the preceding prior art, an object of the present invention is to provide a car audio system with changeable plug-in computer that is capable of changing between different plug-in computer modules and therefrom achieves the goal of upgrading hardware without having to make changes on the car audio.

With the above object in mind, the car audio system with changeable plug-in computer of the present invention has a car audio device comprising a display screen, an audio assembly, an external terminal base and a panel. The panel has at least one inserting slot for storage device and an operating press-button. An inserting slot is disposed at the back of the car audio device to allow the insertion and attachment of the plug-in computer module thereof. The plug-in computer module has a terminal block to butt joint with the external terminal base. By assembling the foregoing assemblies, the present invention is hence capable of changing between different plug-in computer modules and therefrom achieves the goal of upgrading hardware without having to make changes on the car audio itself. Further, with the ability to change between different plug-in computer modules, the present invention is capable of having new functions. The assembling and detaching of the plug-in computer module is easy and convenient.

### BRIEF DESCRIPTION OF THE INVENTION

The detail structure, the applied principle, the function and the effectiveness of the present invention can be more fully understood with reference to the following description and accompanying drawings, in which:

FIG. 1 is an exploded perspective view according to the prior art;

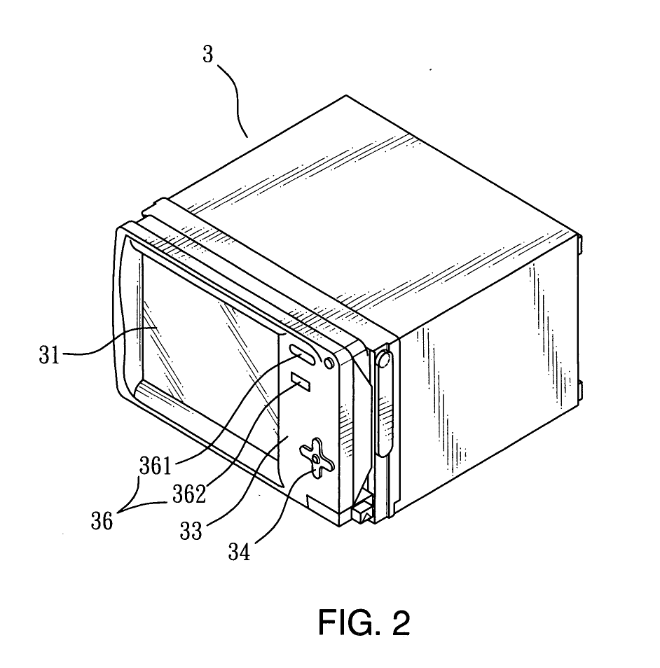

FIG. 2 is a perspective view according to the present invention;

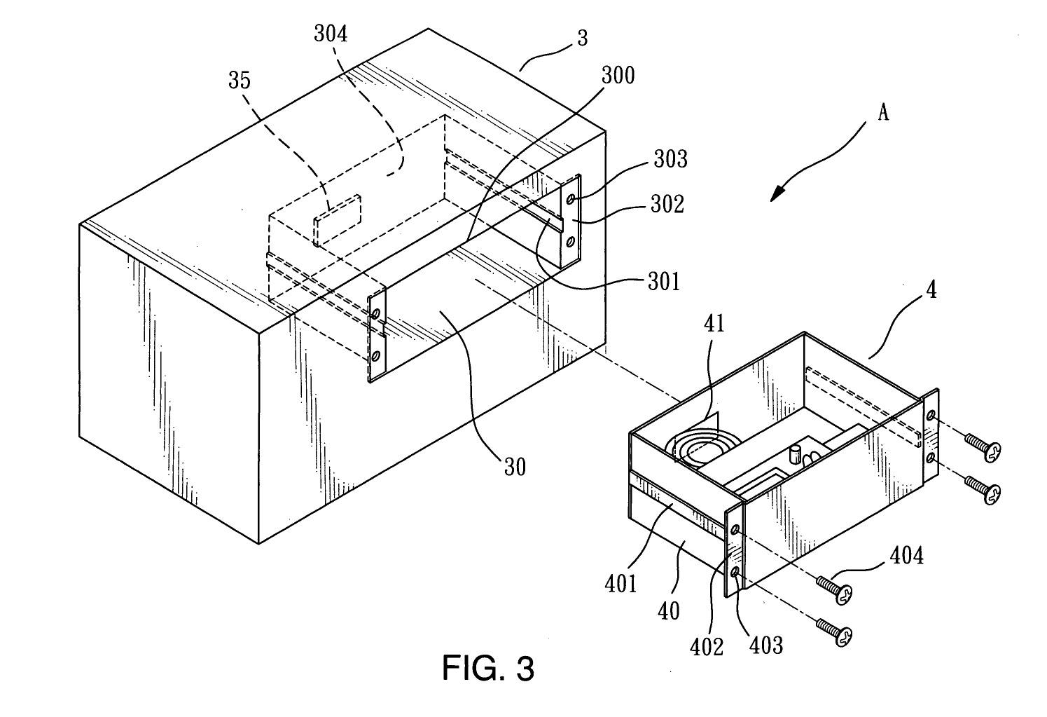

FIG. 3 is an exploded perspective view according to the present invention; and

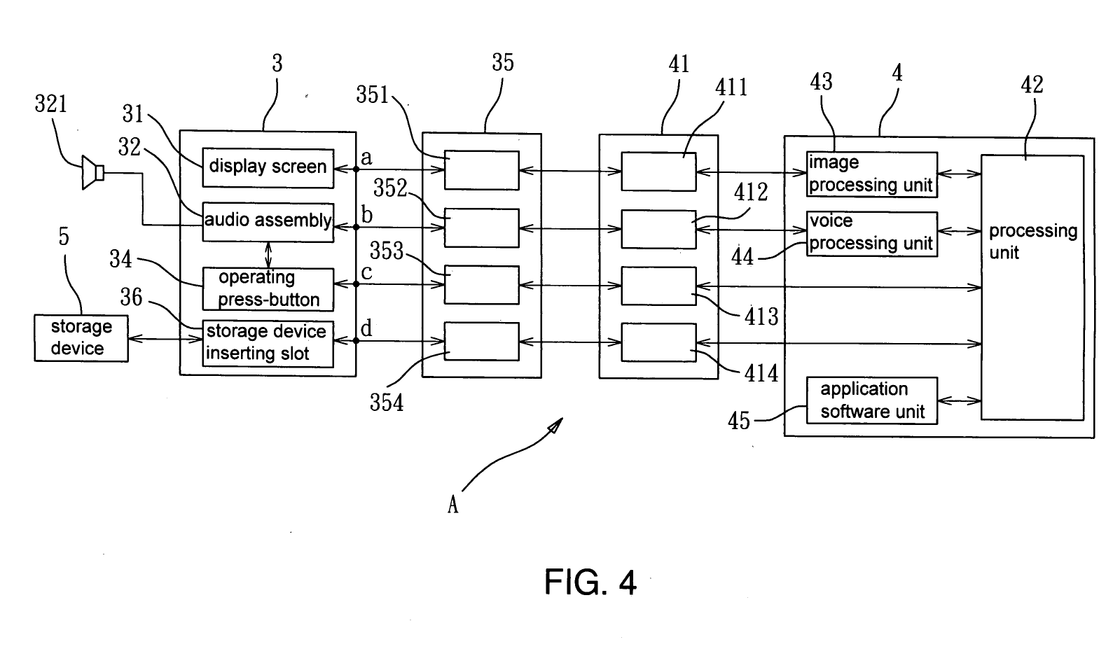

FIG. 4 is a block diagram according to the present invention.

### DETAILED DESCRIPTION OF THE PREFERRED EMBODIMENTS

Referring to FIGS. 2, 3 and 4, car audio A of the present invention is capable of changing between different plug-in computer modules 4 without having to make changes on the car audio device 3. Wherein, the car audio device 3 is disposed inside the car and comprises a display screen 31, an audio assembly 32, an external terminal base 35 and a panel 33. The panel 33 has at least one storage device inserting slot 36 and an operating press-button 34.

An inserting slot 30 is disposed at the back of the car audio device 3 to allow the insertion and attachment of the plug-in computer module 4 thereof. The inserting slot 30 provides a guide groove 301 at each side thereof respectively. Along periphery of a notch 300 of the inserting slot 30 is disposed of at least one first positioning part 302, wherein the first positioning part 302 has at least one positioning threaded hole 303.

The external terminal base 35 is disposed at the back of the car audio device 3, preferably at a front surface 304 of the inserting slot 30 to allow a terminal block 41 of the plug-in computer module 4 to butt joint with the external terminal base 35. The external terminal base 35 consists of a plurality of pins sets 351, 352, 353 and 354, wherein each pins set 351, 352, 353 and 354 comprises at least one pin. The plurality of pins sets 351, 352, 353 and 354 is part of the external terminal base 35 and is each connected with a digital RGB input pin a of the plug-in computer modules 4, a control pin b of the audio assembly 32, a control pin c of the operating press-button 34, and pin d of the storage device inserting slot 36 respectively.

The display screen 31 can be a touch screen and users can thereby directly operate the plug-in computer module 4. Further, the digital RGB input pin a is connected to the pins set 351 of the external terminal base 35 correspondingly.

The audio assembly 32 is directly controlled by the plug-in computer module 4 and comprises at least one operating press-button 34 and a voice channel (in other word, a loudspeaker) 321; wherein the control pin b and c are respectively connected to the corresponding pins sets 352 and 353 of the external terminal base 35.

The storage device inserting slot 36 is disposed at the lateral side of the display screen 31 and comprises a USB inserting slot 361 or a SD inserting slot 362; wherein the pin d of the storage device inserting slot 36 is directly connected to the corresponding pins set 354 of the external terminal base 35 to allow a storage device 5 to plug in and read or write data thereof.

The plug-in computer module 4 has a terminal block 41 disposed at front end thereof; wherein the terminal block 41 butt joints with the external terminal base 35. The terminal block 41 consists of a plurality of pins sets 411, 412, 413 and 414; wherein each pins set 411, 412, 413 and 414 comprises at least one pin. The plug-in computer module 4 further comprises at least one processing unit 42, an image processing unit 43, a voice processing unit 44 and at least one application software unit 45.

The application software unit 45 has at least one audio operating interface software, and further comprises software and hardware that are capable of playing digital format music files.

The plug-in computer module 4 has a guide rail 401 disposed at each of its exterior lateral surface 40; wherein the guide rail 401 is wedged to the guide groove 301 of the inserting slot 30. A second positioning part 402 is disposed at an end of exterior part of the plug-in computer module 4; wherein at least one positioning hole 403 is disposed on the second positioning part 402 and corresponds with the positioning threaded hole 303 of the first positioning part 302 to allow a threaded bolt 404 to screw-lock therein.

The plug-in computer module 4 is capable of being replaced by other plug-in computer modules depending on the different requirements of users. Such as, apply a GPS-featured plug-in computer module 4 when navigation is needed by assembling the plug-in computer module 4 and the car audio device 3. Moreover, the storage device inserting slot 36 of the display screen 31 is controlled by the plug-in computer module 4 and therefore is capable of inputting advanced GPS data.

The car audio A of the present invention is capable of changing between different plug-in computer modules 4 without having to make changes on the car audio device 3. By the replacement of the plug-in computer modules 4, the car audio A is immediately upgraded; further, by the application of the image processing unit 43 (capable of coding and decoding the images), the voice processing unit 44 (capable of processing format of the voice files and playing said voice files) and the screen digital image 2, better display quality and sound effect are thereby provided.

I claim:

1. A car audio system with changeable plug-in computer that is capable of changing between different plug-in computer modules and achieves a goal of upgrading without having to make changes on the car audio device, wherein:
the car audio device comprises an inserting slot disposed at back of the car audio device to allow insertion and attachment of the plug-in computer module thereof; the car audio device further comprises at least:
a display screen, wherein a digital RGB input pin is connected to a pins set of an external terminal base correspondingly;
an audio assembly, wherein at least one operating press-button and a voice channel are provided and two control pins thereof are connected to corresponding pins sets of the external terminal base;
a storage device inserting slot, wherein a pin thereon is directly connected to a corresponding pins set of the external terminal base; and
the plug-in computer module, wherein a terminal block is disposed at its front end thereof and butt joints with the external terminal base, and an application software unit is comprised by the plug-in computer module;
wherein, by assembling the foregoing assemblies, the present invention is hence capable of changing between different plug-in computer modules and therefrom achieves the goal of upgrading without having to make changes on the car audio.

2. The car audio system with changeable plug-in computer as defined in claim 1, wherein at least one second positioning part is disposed at an end of exterior part of the plug-in computer module; the second positioning part is further correspondingly locked with at least one first positioning part of a notch of an inserting slot.

3. The car audio system with changeable plug-in computer as defined in claim 1, wherein a guide rail is disposed at each of the two inserting slots.

4. The car audio system with changeable plug-in computer as defined in claim 1, wherein the storage device inserting slot is a USB inserting slot.

5. The car audio system with changeable plug-in computer as defined in claim 1, wherein the storage device inserting slot is a SD inserting slot.

6. The car audio system with changeable plug-in computer as defined in claim 1, wherein the display screen is a touch screen.

7. The car audio system with changeable plug-in computer as defined in claim 1, wherein the application software unit has at least one audio operating interface software and software and hardware that are capable of playing digital format music files.

8. The car audio system with changeable plug-in computer as defined in claim 1, wherein at least one positioning hole is disposed on the second positioning part and corresponds with a positioning threaded hole of the first positioning part of the notch of the inserting slot to allow a threaded bolt to screw-lock therein.
